(19) United States
(12) Patent Application Publication
(10) Pub. No.: US 2014/0289081 A1
(43) Pub. Date: Sep. 25, 2014

(54) Method and Apparatus for Business Planning using Recurring Revenue Allocation

(71) Applicants: Matthew R. SHANAHAN, Seattle, WA (US); Peter H. HORADAN, Redmond, WA (US)

(72) Inventors: Matthew R. SHANAHAN, Seattle, WA (US); Peter H. HORADAN, Redmond, WA (US)

(21) Appl. No.: 13/848,382

(22) Filed: Mar. 21, 2013

(51) Int. Cl. G06Q 40/00

(52) U.S. Cl. CPC G06Q 40/12
USPC 705/30

(57) ABSTRACT

Access or utilization data of multiple products and services that are offered to customers on a “right-to-use” basis is analyzed to allocate revenues generated by the products fairly among them, for purposes such as business planning, performance measurement and account service.

### CONTINUITY AND CLAIM OF PRIORITY

This is an original U.S. patent application.

### FIELD

The invention relates to data collection and analysis for business planning. More specifically, the invention relates to techniques for measuring and improving the efficacy of resource allocation in businesses which offer customers the right to use goods and/or services, rather than merely the goods and/or services themselves.

### BACKGROUND

Traditional business management principles and processes have developed over centuries to deal effectively with physical goods and services delivered in a transfer of ownership. Agriculture, mining, manufacturing, wholesale distribution, shipping and retail sales all have physical inputs, and invest time or resources to produce physical outputs for sale and delivery to downstream customers. Similarly, services from dentistry to plumbing consume supplies and time, and generally produce desired tangible outcomes for which customers retain ownership (e.g., architectural design). It is usually fairly straightforward to identify and account for the direct input of materials and time, and correlate those costs with the revenues earned from the distribution of the product or service, to decide whether a particular activity is economically viable. Financial products have the same dynamic in that there is distribution of the product (e.g. Loan) in exchange for revenues (e.g., interest).

In contrast to these more traditional businesses, newer commercial activities often involve products and services with a “right to use” model that lack such a direct connection between costs, consumption, and revenues. A simple example of such an activity is offering real estate data for download (or other electronic access). Certainly, there are capitalized costs involved in collecting and aggregating the data, and in maintaining the infrastructure necessary to provide access to it, but there is no strong connection between those capitalized costs and consumption behavior along with the associated revenues that can be earned from the rights to use the data (i.e., some costs may be incurred for which no use and no revenue can be attributed). And when a business provides several different right-to-use products, it may be challenging to analyze the activities to decide whether product or service offerings are selected well, and prices are set efficiently, so as to attract the desired number of customers at the desired level of profitability. New techniques for allocating costs and revenue among right-to-use products and services for business planning purposes may be of significant value to the industry.

### SUMMARY

Embodiments of the invention provide a reliable, deterministic way to allocate revenue among bundled right-to-use products by splitting customers' subscription fees among the products each customer uses, then combining the fee portions by product. Having per-product revenue information allows traditional business analysis techniques to be brought to bear, but the process also exposes information that was not commonly available in the past (and certainly not available without extraordinary collection measures). Embodiments yield the information in a lightweight, explorable form that can be used to develop a deeper understanding of influences and trends affecting the business.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining the core actions of an embodiment.

FIG. 2 shows some features of an environment where an embodiment can be applied.

FIG. 3 outlines a basic use of the data developed according to an embodiment.

FIG. 4 shows how an embodiment can produce service-profit measurements.

FIG. 5 illustrates the use of data developed according to an embodiment in a longer customer-focused process.

### DETAILED DESCRIPTION

Omnibus web portals offer a wide range of information and services, often delivered to consumers through a web browser or browser-like device (including, for example, a smartphone or a tablet computer). Some sites offer their material without charge, while others require payment for some or all items. Common payment models include pay-per-view, time- or volume-limited access and recurring subscriptions. It is not unusual for the exact same resources to be provided to consumers who all pay for the resources differently. Other revenue sources associated with right-to-use product/service provision can include advertising. Such revenue sources can also be analyzed by embodiments of the invention.

As noted earlier, when a site charges fees to access its resources, there is often only a tenuous link between the cost of acquiring, maintaining and delivering the resource; and the revenue earned by selling the right to use it. And when a site offers a variety of resources of differing cost structures, and/or offers right-to-use plans with differing revenue structures, it can be difficult to analyze operational data collected to determine whether some packaging or pricing change would be beneficial (or indeed, simply to compare “before” and “after” results to evaluate a change that was tried).

Embodiments of the invention marry two sets of data and synthesize a new, composite metric that business managers can use in planning and evaluation. In addition, by using specific algorithmic and operational techniques disclosed in commonly-owned patent applications, the data analysis and display can be performed quickly enough to permit real-time re-grouping, data pivoting and “what-if?” manipulations, despite the often enormous amount of data to be processed for display.

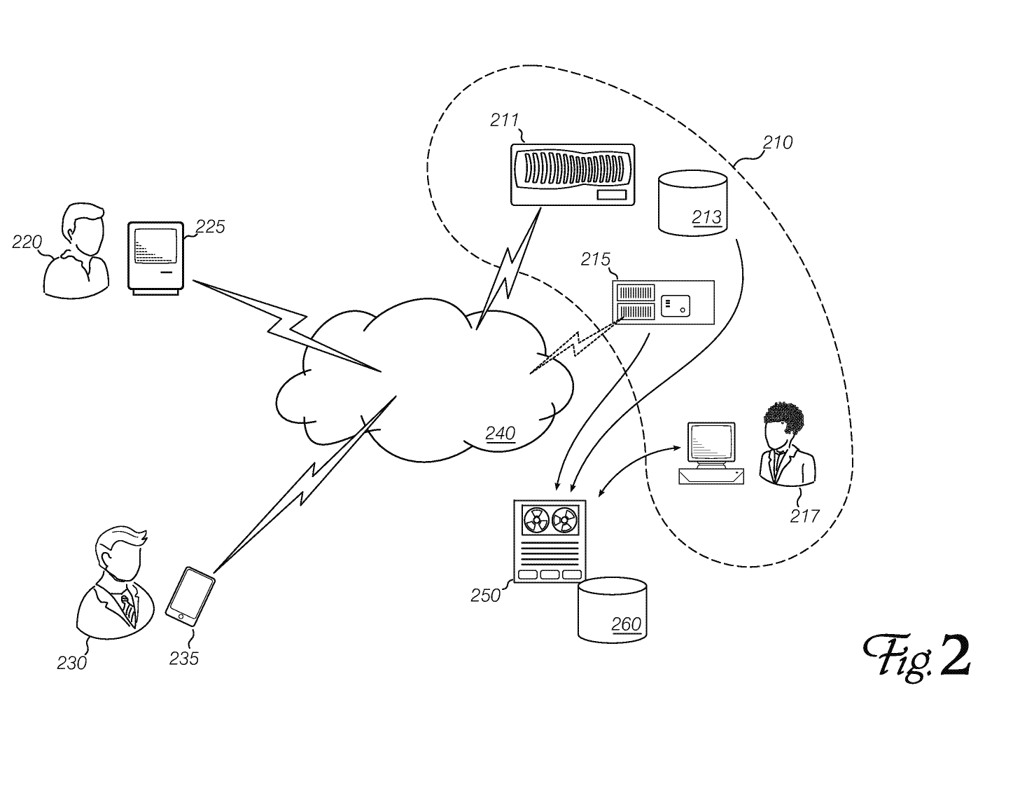

FIG. 2 shows a sample environment where an embodiment of the invention can be applied. A service provider (generally 210) operates a system 211 that provides at least two distinct services to its customers. An embodiment is most useful and effective for analyzing services where the cost of providing an instance or episode of the service to a customer is not strongly correlated with the number of customers to whom the service is provided. A wide range of services fit this description, but for simplicity, we will choose two representatives: managing employee performance evaluations and managing applicant resumes, for use in examples. For these services, the capitalized costs of preparing to offer the service are significant, and must be borne even if only one customer is served. On the other hand, it costs almost zero incremental expense to serve the second customer, or the third. (It is appreciated that increased costs—typically, infrastructure costs—may be incurred if the system is to serve 100,000 users, but again, it costs no more to serve the 100,001^{st} customer than it did to serve the 100,000^{th}.)

Customers 220 and 230 access the services through devices such as a personal computer 225 or a smartphone 235, via a distributed data network 240 such as the Internet. Customer 220 pays a subscription fee of $30/month to access the service, while customer 230 is on a pay-per-use plan. Information about the customers, their contracts and other billing activities are handled by the service provider's accounting system 215.

The system 211 that directly provides the services also collects usage data about who was served, when, and what service was provided. These usage records are stored, for example, in a database 213. The usage records are often numerous: the “service” that the end user perceives is often made up of dozens or hundreds of interactions between the server computer and the customer's computing device. The challenge addressed by embodiments of the invention is to manipulate the usage data available, augment it with certain derived values, and present it to a manager or administrator of the system in a way that is useful for analysis, prediction and other business-planning activities. In some environments, an outside service provider offers computing resources 250 and data storage 260, and performs the manipulations and reporting at the direction of an employee 217, while in other situations, service provider 210 may operate the analysis and reporting infrastructure itself.

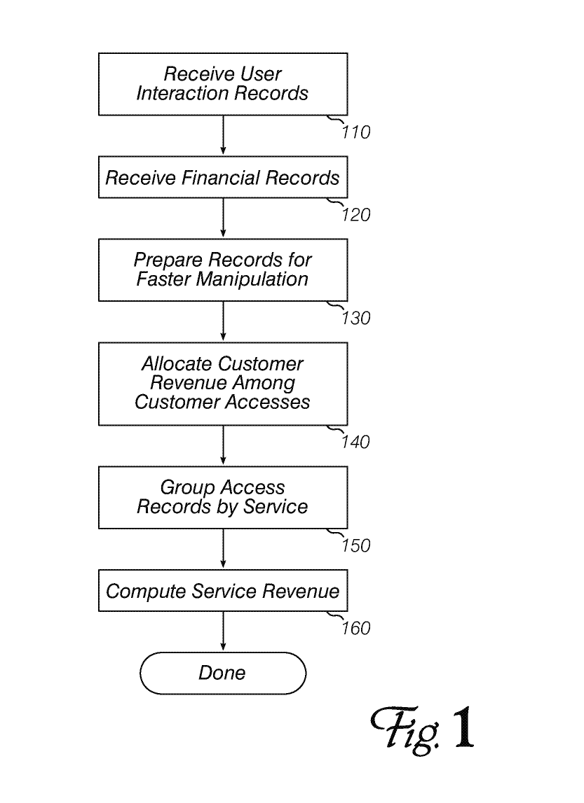

FIG. 1 is a flow chart outlining operations of an embodiment. The system acts on usage data collected by a service provider such as the one described above to produce the composite metric for use in business analysis and planning. The embodiment receives a plurality of usage records reflecting interactions between users of the service provider's resources and the provider's servers (110) and a second plurality of records providing details about each user's financial arrangement with the service provider to use the provider's resources (120). For ease of description, we will adopt a simplistic view of these records: usage records may be thought of as comprising a time stamp, information to associate the access with a user; and information about the resource that was accessed. Similarly, the financial records will be thought of as comprising a user identification (compatible with the “user” element of the access record) and information about the fees paid by the user for the right to access the services. In most practical implementations, each database will include additional information, and other databases may also be merged with the records discussed here to permit a user to pivot to other views, thus exposing other aspects of the system under inspection.

Next, the records are prepared to allow subsequent operations to proceed faster (130). The preparations depend on the nature and content of the source records, but generally do not change the information encoded. For example, the native-format “user” field of an access record may not correspond exactly to the “customer” field of a financial record. Preparation may create a concordance table so that any access record can be associated with revenue from a customer, and/or any revenue record can be associated with a plurality of content accesses made by the customer. The prepared records may be thought of logically as a simple matrix or spreadsheet, though the quantity of data involved would be difficult or impossible to manipulate if it was actually represented that way.

Now, revenue from each customer is allocated among the usage records of the customer (140), according to an appropriate formula. A simple allocation would divide the total revenue from a user over a time period among the user's usage records for the same period. However, this simple method is generally unsatisfactory, since access records commonly include records for things like background images, decorative items, and menus, as well as records for accesses to the resources or services that a user perceives as the “product” he has purchased. Other methods of allocating revenue from a user among his accesses are discussed below.

The revenue allocation step may be repeated to set per-access revenues by a number of different methods, which will allow the prepared database to answer questions such as “what is the straight-division revenue earned by this access?” or “what is the popularity-weighted revenue earned by this access?” without having to re-scan and re-process the source data.

Finally, the access records are grouped by service (or by resource) (150) and the allocated revenue(s) summed to give an estimate of the total revenue earned by the service (or by the resource) over the time period (160).

The foregoing method accomplishes a deterministic, repeatable allocation of recurring revenue among a plurality of services, which is useful for business performance analysis and planning purposes. It is important to distinguish this allocation from a simple summation-and-division averaging, where one might add all the revenues (from all users), and divide among all accesses (again, from all users). Although this averaging may produce similar results in some analyses, it obscures or discards information that could help managers understand and advance the business.

The following simple example illustrates differences between revenue allocation according to an embodiment, and ordinary averaging. Consider two users, Alice and Bob, each of whom pays $100/month for the right to use two services, X and Y. Alice uses X 40 times and Y 10 times, while Bob uses X 5 times. Thus, by the simplest revenue allocation embodiment, Alice pays $2 for each use of X or Y ($80 total for X and $20 total for Y), while Bob pays $20 for each use of X ($100 total for X). Therefore, the embodiment would attribute revenue of $180 to service X and $20 to service Y. In contrast, an averaging approach might allocate

$$\$163 .44 ( \$200 \times \frac{45}{55} )$$

to service X and

$$\$36 .36 ( \$200 \times \frac{10}{55} )$$

to service Y.

Service

| User | Fee | X | Revenue | Y | Revenue |
|---|---|---|---|---|---|
| Alice | $100 | 40 | $80 | 10 | $20 |
| Bob | $100 | 5 | $100 | 0 | 0 |
| Total | $200 | 45 | $180 | 10 | $20 |

(Revenue Allocation)

Service

| Users | Fees | X | Revenue | Y | Revenue |
|---|---|---|---|---|---|
| Alice & | $200 | 45 | $163.64 | 10 | $36.36 |
| Bob | | | | | |
| | $200 | 45 | $163.64 | 10 | $36.36 |

(Averaging)

The latter allocation might suggest that X is not earning enough to pay for itself, or that Y is more profitable than it really is. But perhaps a more critical difference is that the averaging approach irretrievably drops important information. It cannot, for example, identify the user who pays the least for service X, or pursue that identification through to a list of other services accessed by that user. Improved ability to “explore” the data is a key benefit offered by an embodiment of the invention.

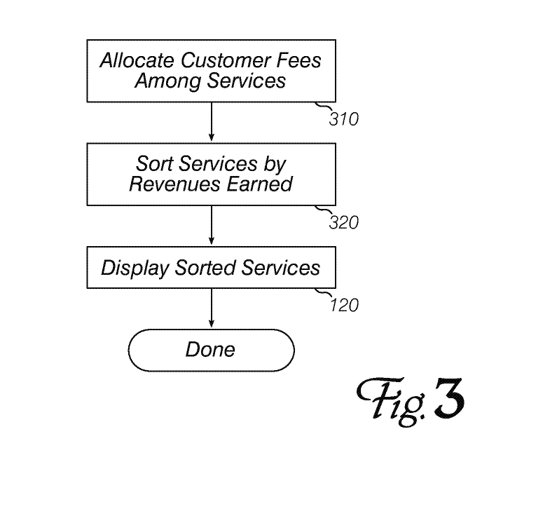

Once customer revenues have been allocated among accesses and then attributed to services according to the method outlined above, an embodiment can produce a variety of useful reports or trigger other actions. For example, FIG. 3 outlines a method for creating the simplest report: after allocating customer revenue among the services (310), the embodiment sorts the services by revenue earned (320) and displays the sorted list of services (330). This permits the user to gauge the relative importance of services to revenues (but not, of course, to compare service profitability.)

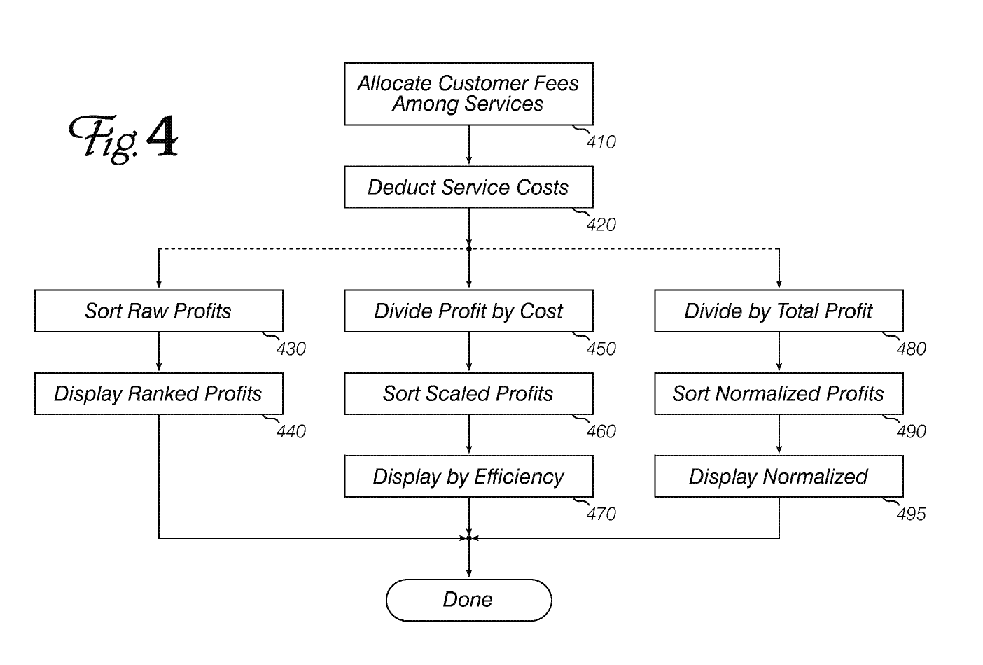

For profit comparisons (FIG. 4), the system allocates customer revenue among the services (410), then deducts service costs (420) to produce a profit estimate. The raw profits can be sorted (430) and displayed (440); divided by service expense (450), ranked (460) and displayed (470) to highlight particularly capital-(in)efficient services; or divided by total profit (480), ranked (490) and displayed (495) to make normalized comparisons with data from other time periods.

The various sorted displays discussed above are not per se diagnostic (i.e., there is no single ranking that always indicates some particular business situation or condition). Instead, embodiments of the invention are valuable because they offer repeatable and (when normalized) comparable statistics that identify products and services that are functioning differently than other products that the business offers. By finding outliers (things that earn the lion's share of revenues, or negligible revenues; things that are highly profitable or that appear to be losing money; and so on) managers can focus their attention on portions of the business which are more likely to be involved in the achievement of stated goals.

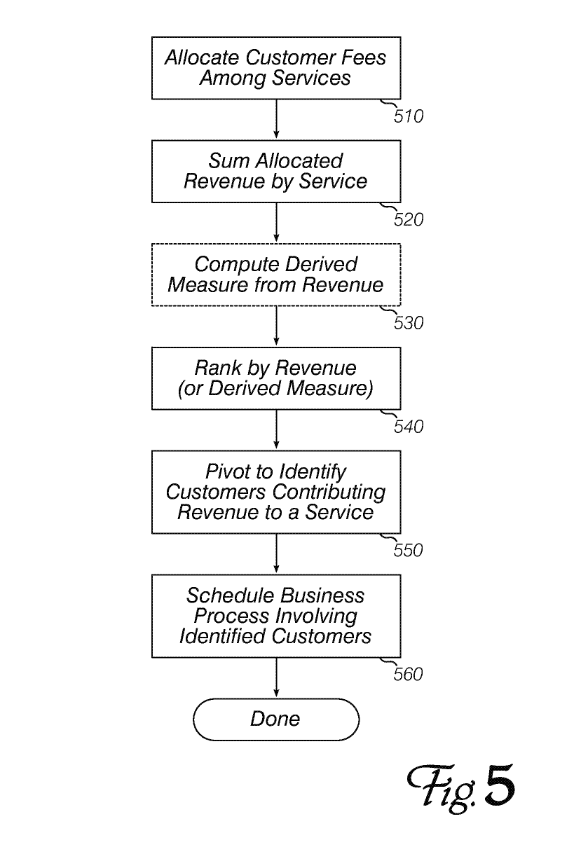

Furthermore, the allocation of revenue to services and subsequent ranking, can serve as an intermediate step in targeting particular groups of customers. For example, once the most profitable service is identified (according to a particular revenue allocation strategy), an embodiment may be used to execute a further data pivot to show customers who used that service, notwithstanding that some of those customers may have paid a smaller fee for their own usage of the service, or may not have used the service often enough to show up in a straight ranking of “who uses what?” In other words, as outlined in FIG. 5, an embodiment may allocate customer revenue among a plurality of services (510), sum allocated revenues by service (520), (optionally) compute a derived measure based on the allocated, summed revenues (530), sort the services by the revenue (or by the derived measure) (540), and then identify users of a predetermined one of the services (550) and schedule a business process targeting those users (560). For example, the system may send an electronic message to the users, schedule a workflow item in a Customer Relationship Management (“CRM”) system to attempt an in-person contact of the user, offer a discount or rebate on subscription fees, or initiate an account review to increase the subscription price.

Now we return to the question of how to divide customer revenue among the customer's accesses, before adding the revenue portions together to compute service revenue. As previously explained, it is simple, but unlikely satisfactory, to divide the revenue from a customer over a period of time, by the total number of client/server interactions with the customer over the same period of time, to produce revenue-per-interaction. One improvement over this method is to separate access records into at least two classes (for example, general access and service-specific access) and then weight the revenue allocation differently between the classes. For example, background images, menu lists, “splash” pages and account-management pages may be considered “general” use, and be allocated a smaller share of customer fees, a fixed share of customer fees, or no share of customer fees. Accesses in the other (or another) class may be allocated revenue on a straight per-access basis (fees divided by total number of accesses in that class) or on a weighted basis, where the weight is proportional to a metric such as the size of data communicated in the access, the cost of providing the data (if there is a per-access licensing fee or other fixed cost associated with the access), the non-subscription or a la carte price of accessing the service (if such access is offered), the length of time the access continues (for a streaming access), or by another similar metric. Note that this is a weighting process, where the total revenue from a user is divided up, evenly or unevenly, and allocated among services that the user accessed. In most embodiments, services that the user did not access will not be accounted as having earned any revenue from that user, even though the user may consider the mere right or ability to access such services to be part of the value of the subscription. Also, in most embodiments, the weighted allocation is designed so that the sum of revenues allocated to services used by a customer, is equal to the fees paid by the customer. It is likely that fees from two different customers will be allocated differently among the services used by the customers, even if they pay the same numeric amount. Furthermore, the per-interaction revenue allocated to each service is likely to differ from one user to another (in other words, users are likely to “pay” a different amount for each use of a service, even if their total monthly payments are the same.)

It is appreciated that the ability of an embodiment to perform such fine-grained allocation of customer revenue to customer activity is significantly different from what has gone before. In traditional businesses, a seller of (for example) an agricultural implement has no idea what a customer does with the product he purchases: how often he uses it, or how much time he spends with it. A publisher generally cannot tell whether a book, magazine or newspaper was ever read, read once, or whether it was passed around and read widely. In the environment where an embodiment operates, however, it is often possible to determine these things, and embodiments of the invention help a business act effectively on the basis of that knowledge.

Inventors observe that detailed data collection (which is clone as a matter of course in many electronic service environments) is now possible, and increasingly being implemented, in real-world environments as well. Embodiments of the invention can be applied to analyze and improve the operation of such environments. A brief real-world example follows; it is hoped that this will provide additional useful insights to one of ordinary skill, seeking to implement an embodiment of the invention.

Consider a health or fitness club which offers its customers the right to use its facilities on a per diem, monthly or annual subscription basis. Further revenue complexity might result from grandfathered low-price plans, group discounts, and service-level differences (e.g., some plans may not allow the customer to use certain club facilities). Thus, as in the foregoing examples, customers are likely to pay different amounts for the right to use the facilities over any particular period of time. Furthermore, it is likely that individual customers will make different actual use of their subscriptions: some will exercise regularly and often, while others will visit occasionally or not at all.

Next, consider that the club has capital equipment, including (for example) a treadmill and a sauna. These items have an acquisition cost, as well as maintenance and repair costs. How is the club operator identify equipment that “earns its keep,” or to distinguish between repair costs for a frequently-used, popular machine and repair costs for a machine that is simply too fragile for commercial use?

By collecting usage data, analogous to that collected in the electronic/data service environments discussed above, the club operator can apply an embodiment of the invention to allocate customer subscription fees among the facilities each customer uses, and then aggregate the fees earned by each facility to estimate revenue earned by the facility over a period of time. The usage data must provide the embodiment with a way to match customer fees to customer usage of each machine or facility. Systems to collect this data may be passive (e.g., based on image processing) or active (e.g., based on customer identifying tokens, such as RFID badges or wristbands). Customers may accept this data collection (which initially may appear to be unreasonably intrusive) if it is done as part of a game or competition among members (e.g., to see who runs the farthest or lifts the greatest total weight). The per-facility revenue estimate supports business decisions and planning, such as the choice to repair (or add another) treadmill, or to decommission the sauna.

It is appreciated that real-world implementations of the embodiment may have to account for an added “opportunity cost” factor for a facility. For example, although computer services can often be accessed by multiple users at essentially the same time, many physical devices such as treadmills can only be used by one person at a time. Thus, all other circumstances being equal, the revenue a treadmill can earn is limited by the number of hours it can be in operation. So although a computer service might be able to increase its revenue simply by attracting more customers, a health club that wishes to increase its “treadmill” earnings may have to purchase another machine. The cost of this acquisition and the incremental maintenance costs must be factored into the business case analysis.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that recurring revenue can be allocated among multiple products for business planning by software and hardware that distribute the functions of embodiments of this invention differently than herein described. Such variations and implementations are understood to be captured according to the following claims.

We claim:

1. A method comprising:
operating an electronic data service that provides a plurality of different types of electronic information to a plurality of subscribers;
receiving from each subscriber a usage fee that entitles the subscriber to access the plurality of different types of electronic information;
allocating a first portion of the usage fee from each subscriber to a first type of electronic information;
allocating a second portion of the usage fee from each subscriber to a second type of electronic information;
computing sums of the usage fees allocated to the first type of electronic information and the second type of electronic information; and
preparing a report comparing the first type of electronic information and the second type of electronic information according to a function of the computed sums.

2. The method of claim 1, further comprising:
recording information about accesses by each subscriber to the electronic data service, and wherein the allocating operations comprise:
counting a number of accesses by each subscriber to the first and second types of electronic information; and
allocating the first and second portions of the usage fee from each subscriber in proportion to the number of accesses by each subscriber to the corresponding type of electronic information.

3. The method of claim 1, further comprising:
selecting one of the first and second types of electronic information according to the function of the computed sums; and
selecting a subset of subscribers of the plurality of subscribers, wherein a portion of the usage fee paid by each of the subscribers of the subset was allocated to the selected one of the first and second types of electronic information.

4. The method of claim 3, further comprising:
for each subscriber of the subset, scheduling an event involving the subscriber in a Customer Relationship Management (“CRM”) system.

5. The method of claim 3, further comprising:
for each subscriber of the subset, adjusting the usage fee paid by the subscriber.

6. The method of claim 1 wherein the first type of electronic information is employee performance information.

7. The method of claim 1 wherein the first type of electronic information is employment applicant information.

8. The method of claim 1 wherein the first type of electronic information is digital audiovisual media streams.

9. A method comprising:
loading a plurality of access records, each access record memorializing an interaction between a client computer and a server computer;
grouping the plurality of access records by an associated user to identify interactions between the associated user and the server computer;
allocating a fee paid by the associated user among the interactions between the associated user and the server computer so that each interaction has an estimated revenue;
re-grouping the plurality of access records, each with an estimated revenue, as associated with one of a plurality of services;
computing total revenue earned by the associated service as a sum of estimated revenues associated with access records regrouped to the associated service; and
identifying one of the plurality of services as having an extreme value of a function of the total revenue earned by the service.

10. The method of claim 9, further comprising:
identifying at least one user, part of whose fee paid was allocated to the identified one of the plurality of services; and
scheduling an interaction with the at least one user in a Customer Relationship Management (“CRM”) system.

11. The method of claim 9 wherein the function of the total revenue earned by the service is the total revenue earned by the service.

12. The method of claim 9 wherein the function of the total revenue earned by the service is the total revenue earned by the service less a cost attributable to providing the service.

13. The method of claim 9 wherein the function of the total revenue earned by the service is the total revenue earned by the service, less a cost attributable to providing the service; divided by a total revenue earned by all of the services less a cost attributable to providing all of the services.

14. A non-transitory, computer-readable medium containing instructions and data to cause a programmable processor to perform operations comprising:
estimating revenue earned by each service of a plurality of services as a sum of subscription fees paid by a plurality of users of the plurality of services, wherein each subscription fee is allocated among the plurality of services according to a usage of each service by the user paying the subscription fee;
grouping a plurality of service access records by a first grouping criterion;
sorting the grouped service access records by the estimated revenue of the service; and
displaying summaries of the sorted, grouped service access records in a tabular form.

15. The computer-readable medium of claim 14, containing additional instructions and data to cause the programmable processor to perform operations comprising:
re-grouping the plurality of service access records by a second, different grouping criterion;
sorting the re-grouped service access records by the estimated revenue of the service; and
displaying summaries of the sorted, re-grouped service access records in a tabular form.
